(19) United States
(12) Patent Application Publication
(10) Pub. No.: US 2010/0089238 A1
(43) Pub. Date: Apr. 15, 2010

(54) Method for Dissolving, Recovering and Treating a Gas, Installation for the Stocking of a Gas and Its Method of Manufacture

(75) Inventors: Sylvain Miachon, Lyon (FR); Sylvie Lemeulle, Lyon (FR); Mae Miachon-Lemeulle, Lyon (FR); Telio Miachon-Lemeulle, Lyon (FR); Marc Pera Titus, Villeurbanne (FR); Volaniaina Rakotovao, Lyon (FR); Jean-Alain Dalmon, Lyon (FR)

Correspondence Address: MILLER, MATTHIAS & HULL, ONE NORTH FRANKLIN STREET, SUITE 2350, CHICAGO, IL, 60606, US

(73) Assignee: Centre National de la Recherche Scientifique, Paris (FR)

(21) Appl. No.: 12/329,309

(22) Filed: Dec. 5, 2008

(30) Foreign Application Priority Data
Oct. 15, 2008 (FR) 08 57011

(51) Int. Cl. B01D 53/18; C23C 16/44

(52) U.S. Cl. 95/203; 95/213; 95/187; 96/296; 96/251; 96/253; 427/248.1; 977/700

(57) ABSTRACT

Method for the dissolution of a gas in an input gas flow, in which a soaked solid comprising a porous substrate comprising pores each having a size less than 100 nanometres (nm) and each containing a solvent of the gas, is swept with the input gas flow comprising at least the gas.

### FIELD OF THE DISCLOSURE

The present disclosure relates to methods for dissolving, recovering and treating a gas, installations for the stocking of a gas and their methods of manufacture.

### BACKGROUND OF THE DISCLOSURE

Carbon dioxide (CO₂) is regarded as one of the main promoters for climate change, accounting itself for approximately 70% of the gaseous radioactive force responsible for the greenhouse effect due to human activity (UK Stern Review: ‘The economics of climate change’). The burning of fossil fuels for energy production (electricity and heat) is the prime global source of CO₂, reaching 25000 Mtm CO₂ in 2003. According to IEA-OECD estimates, this sector accounted itself for 35% of global CO₂ emissions in 2002, with an annual increase of approximately 33% in the period 1990-2002.

For years, efforts have been made to separate CO₂ from the other gases produced during combustion, in order to store or re-process it, and thus prevent it from contributing to the greenhouse effect. The most widely used method today is “amine bubbling”, an example of which is given in U.S. Pat. No. 6,500,397. In this method, the gaseous mixture passes through a monoethanolamine solution, in which the CO₂ is dissolved. The CO₂ is then recovered by heating the solution. However, as the volume of dissolved CO₂ is small with respect to the volume of the solution, the energy cost of the CO₂ recovery, linked to the heating of a large solution volume, is substantial. As a result, a more profitable method for the collection of CO₂ is still sought.

There are many other applications where there is a need for alternative ways of solving a gas. Another possible application is H₂ (dihydrogen) storage. In this field, the US department of energy recently set target values for the storage capacity of hydrogen to 65 and respectively 90 gram H₂/kg solid for the years 2010 and 2015.

There are still other applications which might benefit from alternative methods of dissolving gases.

### SUMMARY OF THE DISCLOSURE

To this end, a method is proposed for dissolving a gas, in which a soaked solid comprising a porous substrate comprising a plurality of pores each having a size less than 100 nanometres (nm) and each partially filled by a solvent of said gas, is swept with an input gas flow comprising at least said gas.

In fact, the inventors recently very surprisingly observed a phenomenon of oversolubility of gases in a solvent contained in a mesoporous solid.

While the solubility of a gas in a solvent generally obeys Henry's law C=HP, where C is the concentration of the gas in the solvent, H the Henry constant of the gas, and P the pressure of the gas above the solvent, it was recently found that, when the solvent was contained in a porous solid having small pores, this law was no longer obeyed, and in fact the concentration of the gas was much greater than that predicted by Henry's law.

In preferred embodiments, use can furthermore optionally be made of one and/or another of the following provisions:

the solvent is a physical solvent;

the solvent is a chemical solvent;

the input gas flow is placed in contact with the solvent contained in the pores;

a concentration of said gas in an output gas flow from the soaked solid is monitored;

said gas is carbon dioxide, to be collected from an input gas flow resulting from a combustion and further comprising at least dinitrogen [N₂];

said gas is dihydrogen (H₂) and said input gas flow comprises substantially only said gas;

more than 2 g of H₂ per kilo of dry solid are dissolved at 2 bars and 276 K,

the method comprises sweeping a porous substrate having a ratio of surface area to volume of less than 100 m²/cm³, preferably of less than 50 m²/cm³;

he input gas flow comprises water vapour.

According to another aspect, the disclosure is related to a method of treatment of a gas comprising such a method for dissolving a gas, and further comprising a recovery step of the gas dissolved in the pores.

In some embodiments, one might also use one or more of the following features:

the soaked solid is kept in a gaseous environment, and the recovery step comprises a pressure variation of the gaseous environment;

the recovery step comprises a temperature variation of the soaked solid;

the sweeping and recovery are carried out alternately and repeatedly;

the input gas flow is sent alternately to a first and a second soaked solid, one of the soaked solids being submitted to a recovery step when the other is swept by the input gas flow.

According to another aspect, the disclosure is related to a method of generating an output gas flow, wherein a gas is recovered from a soaked solid comprising a porous substrate comprising a plurality of pores each having a size less than 100 nanometers (nm) and each partially filled by a solvent of said gas.

According to another aspect, the disclosure relates to an installation for the stocking of a gas comprising a soaked solid comprising a porous substrate comprising a plurality of pores each having a size less than 100 nanometres (nm) and each partially filled with a solvent of the said gas.

According to another aspect, the disclosure relates to an installation for the collection of a gas comprising such an installation and further comprising an input device adapted to introduce an input gas flow comprising at least said gas, suitable for sweeping the soaked solid with the input gas flow.

According to some embodiments, one might also use one or more of the following features:

the installation further comprises an output device adapted to release an output gas flow comprising at least said gas;

the installation also comprises at least one and preferably all of the following characteristics:

a temperature regulation device adapted to regulate the temperature of the soaked solid,

a pressure regulation device adapted to regulate the pressure of an atmosphere in which the soaked solid is contained,

a monitoring device adapted to monitor the content of said gas in an output gas flow;

the input device is adapted to introduce a gaseous input mixture resulting from a combustion, and comprises at least carbon dioxide as said gas, and nitrogen [N₂];

said gas is dihydrogen, and said input gas flow comprises substantially only said gas;

over 2 g of H₂ are dissolved per kilo of dry solid at 2 bars and 276K.

According to another aspect, the disclosure relates to a method of manufacture of an installation for the stocking of a gas comprising:

manufacturing a porous substrate comprising a plurality of pores each having a size less than 100 nanometres (nm),

partially filling the pores with a solvent of said gas,

supplying an input device adapted to introduce an input gas flow comprising at least said gas, suitable for sweeping the solvent with the input gas flow.

According to some embodiments, one might also use one or more of the following features:

said gas is CO₂, the input gas flow is a gaseous input mixture resulting from a combustion and further comprising at least nitrogen;

said gas is H₂, the input gas flow substantially comprises only said gas.

According to another aspect, the disclosure relates to a method for the collection of CO₂ in a gaseous mixture resulting from a combustion, in which a soaked solid comprises a porous substrate comprising a plurality of pores each having a size less than 100 nanometers (nm) and each partially filled by a solvent of CO₂, is swept with a gaseous input mixture comprising at least CO₂ and nitrogen [N₂].

Other characteristics and advantages will become apparent from the following description of one of its embodiments, given as a non-limitative example, with reference to the attached drawings.

### BRIEF DESCRIPTION OF THE DRAWINGS

In the drawings:

FIG. 1 is a schematic view of a first example of a collection installation,

FIG. 2 is an enlarged view of a pore used in the installation of FIG. 1,

FIGS. 3a, 3b and 3c are schematic diagrams representing three examples of materials which can be used in the installation of FIG. 1,

FIG. 4 is a schematic view of a second embodiment of a collection installation, and

FIG. 5 is a diagram comparing experimental results for solubility in four cases, showing on the x-axis the pressure (bar) of an enclosure containing the soaked solid and on the y-axis the concentration of dissolved CO₂,

FIG. 6 is a schematic view of a second embodiment of an installation,

FIG. 7 is a diagram of solubility results of H₂ in different solvents and different solids,

FIGS. 8a-8d are diagrams of results of solubility of various gases in different solvents and solids.

In the different figures, the same references denote identical or similar elements.

### DETAILED DESCRIPTION

FIG. 1 shows schematically an installation 1 for the collection of a gas. In a first embodiment, this gas can, for example, be CO₂. This installation comprises a gas-feed line 2 opening into an enclosure 3 from which a gas-discharge line 4 leaves. An inlet valve 5 and an outlet valve 6 make it possible to open or close the gas-feed line 2 or, respectively, the gas-discharge 4 line, as desired.

The gas-feed line 2 carries an input gas flow which in the first embodiment, can be a gaseous mixture resulting from a combustion, for example located in a factory, a thermal power station, or other, to the enclosure 3. The input gas flow contained in the feed line 2 is a typical gas mixture obtained after a combustion, and comprising for the most part dinitrogen [N₂], generally at a level of at least 50%. The gaseous input mixture also comprises a substantial quantity of carbon dioxide [CO₂]. Other gases can be included in the gaseous input mixture 2, such as water vapour, carbon monoxide, nitrogen oxides [NO,NO₂], or other.

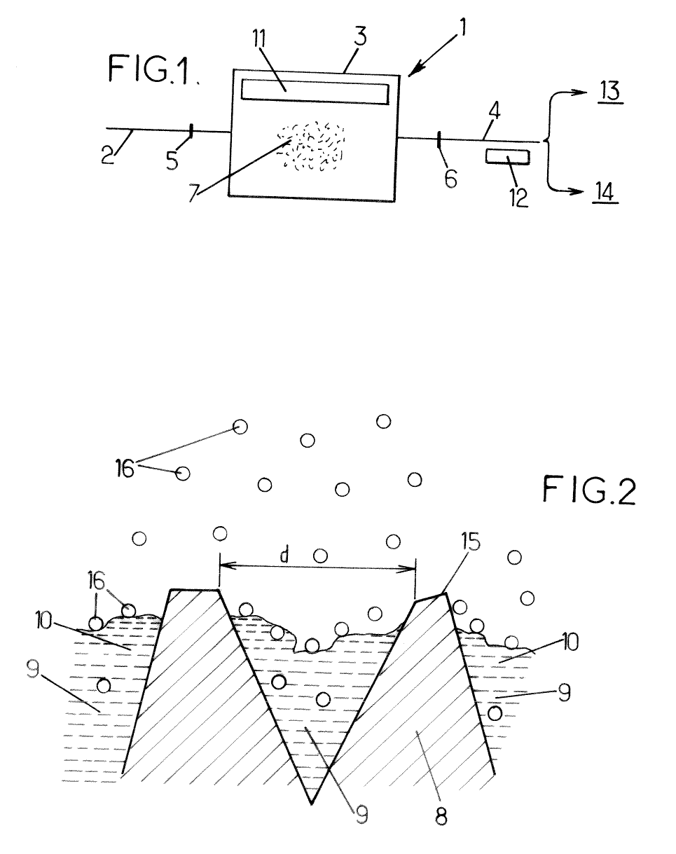

The gaseous input mixture is carried by the gas-feed line 2 into the enclosure 3 where there is located a soaked solid 7 intended for the collection of the carbon dioxide from the gaseous input mixture. This soaked solid 7 can for example be in powder or pellet form, in the form of rods, rings or tubes or in any other suitable form. It is constituted by a mesoporous solid 8 containing in its pores 9 a liquid solvent 10 which, in the first embodiment, is a solvent 10 of the carbon dioxide (FIG. 2).

As a mesoporous solid, there may be used for example a γ-alumina GFS400 produced by the company Rhône-Poulenc, a silica 432 produced by the company Grace Davisson, a MCM-41, or other.

By way of example, the structural characteristics of the solids used are listed in the table below:

TABLE 1
Characterization of the texture of the solids
described, based on N₂ adsorption at 77K

| | γ- | | MCM- |
|---|---|---|---|
| | alumina | silica | 41 |
| Skeletal density (g cm⁻³) | 3.5 | 2.1 | 2.1 |
| Specific surface area BET (m² g⁻¹) | 235 | 309 | 1065 |
| Pore volume (BDB^{(a)}) (cm³ g⁻¹) | 0.62 | 1.12 | 1.09 |
| Average pore size (BJH^{(b)}) (nm) | 10.9 | 13.0 | 3.4 |

^{(a)}Broekhoff-de-Boer;
^{(b)}Barrer-Joyner-Halenda

These characteristics were measured by volumetric analysis (He density and N₂ adsorption at 77 K) using a Micro Meritics ASAP 2020 apparatus.

Another solid material of interest is MCM-41 with a ratio of Si to Al equal to 1. It has the following characteristics:

TABLE 2
Characterization of the texture of the solids
described, based on N₂ adsorption at 77K

| | MCM-41 (Si/Al = 1) |
|---|---|
| Skeletal density (g cm⁻³) | 2.2 |
| Specific surface area BET (m²g⁻¹) | 506 |
| Pore volume (BDB^{(a)}) (cm³ g⁻¹) | 0.220 |
| Average pore size (BJH^{(b)}) (nm) | 3.1 |

^{(a)}Broekhoff-de-Boer;
^{(b)}Barrer-Joyner-Halenda

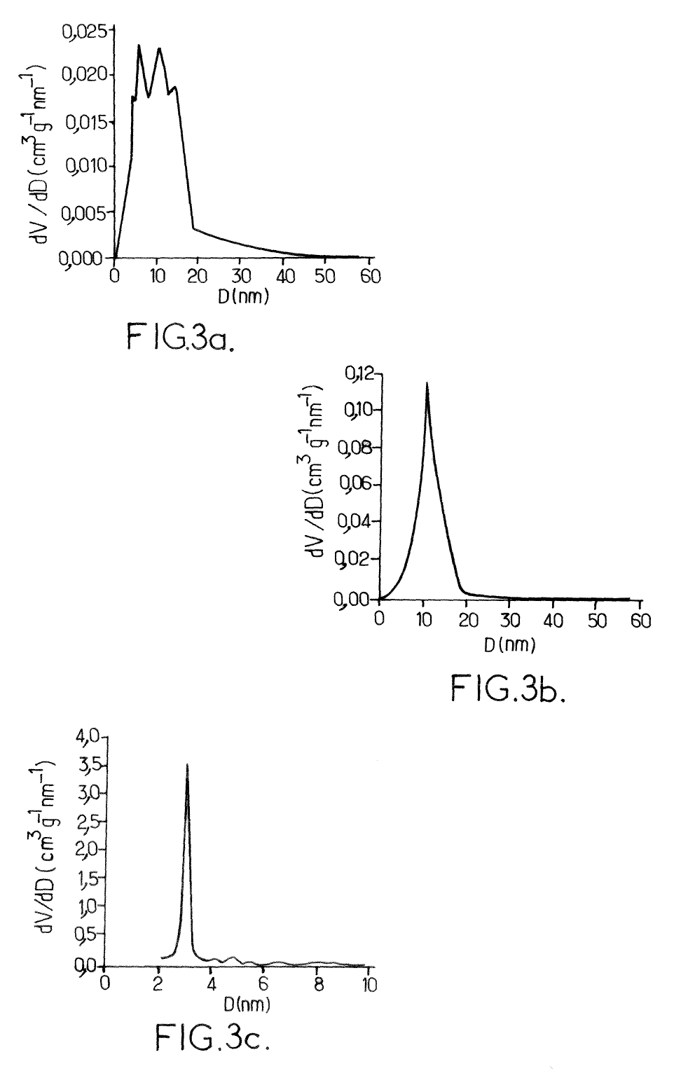

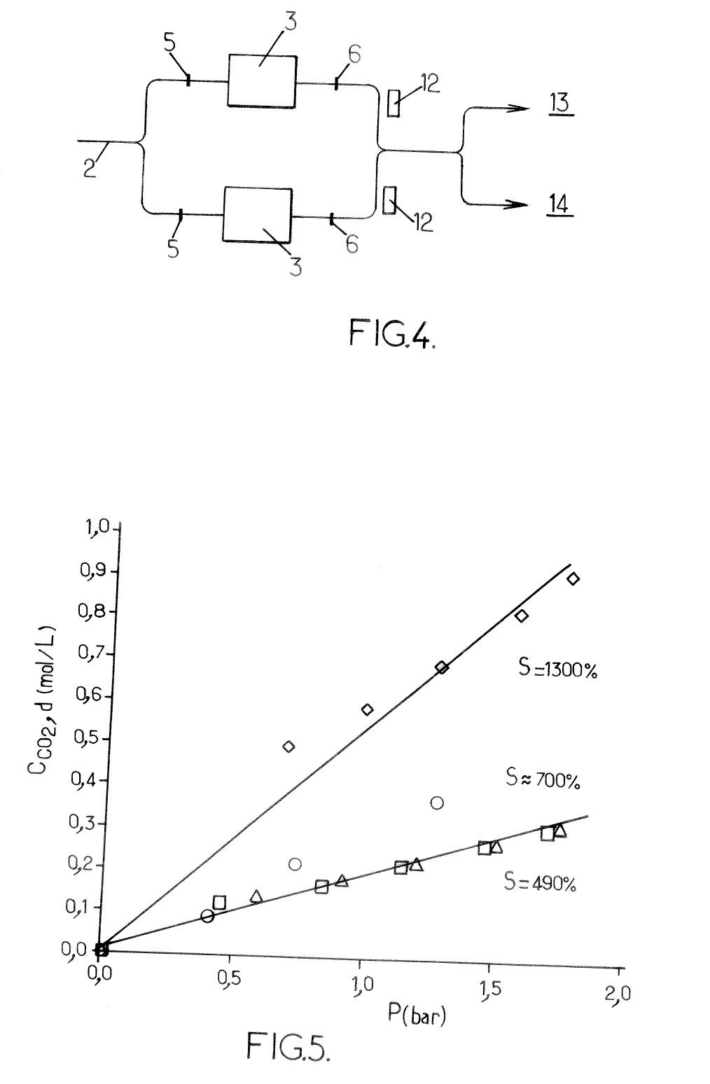

FIGS. 3a, 3b and 3c represent, respectively, the pore-size distribution of the three materials listed above (γ-alumina, silica, MCM-41), as obtained from the nitrogen adsorption isotherms. MCM 41 has a lower pore size distribution, which enhances the solubility.

Although the data described above for three examples of materials are very specific, the subject matter disclosed herein may be implemented with solid materials which can have different characteristics, in particular aerosol silicas, MCM silicas (containing aluminium or not), etc. Conceivable values for the above parameters, while still remaining within the scope of the disclosure, can be summarized as follows:

pore volume (BDB) (cm³g⁻¹) comprised between 0.1 and 2000 [i.e. a range of approximately 20% to 99% when the pore volume is expressed as a percentage of the total volume],

average pore size (BJH) (nm) comprised between 1 and 100 nanometres (nm), in particular between 1 and 15-20 nanometers.

Although there are technically no reasons to think that the subject matter disclosed herein could not be implemented for pores of a size less than 1 nm, there is currently a technological limit as regards the manufacture of such solids (pores smaller than 1 nm).

In FIG. 2 a pore six nanometres in diameter (d), the solvent, as well as various molecules 16 of CO₂ dissolved or still present in the gaseous atmosphere, have been represented at a realistic scale overall.

Thus, as shown in this figure, the liquid is completely confined in the pores.

The majority of the pores should have a size (average diameter d, represented in FIG. 2, between two edges of the solid material) less than 100 nanometres, preferably less than 50 nanometres for at least 90% of the pores, preferably also less than 20 nanometres for at least 50% of the pores.

These pores are partially filled with solvent, the latter not going beyond the edges of the solid material, so as to maximize the exchange surface.

As regards the liquid solvent of the gas, two main types can be used:

chemical solvents, in which the dissolution of the gas takes place by a chemical reaction: when it comes to CO₂, a typical example is an aqueous amine, or monoethanolamine (MEA), solution of the type described in U.S. Pat. No. 6,500,397, and similar,

physical solvents, such as, in the case of CO₂, for example acetones, polyethylene glycols, or other.

FIG. 5 represents results of experiments showing the effect of the confinement of acetone in the pores of a silica aerosol on the observed solubility of the CO₂. In this example, the solubilities of the gas were measured by microvolumetric analysis. According to this technique, the sample (for example a liquid or a soaked solid, as appropriate), is firstly placed in an enclosure and degassed. The enclosure is then placed in contact with a reference volume, the CO₂ pressure of which is completely known, and at a given temperature (for example ambient temperature). The pressure reduction due to the expansion of the gas towards the cell can be translated into a dissolved concentration by a simple mass balance. The experiments were carried out for three different situations:

volumic system (CO₂+acetone, represented by circles),

CO₂ and silica aerosol completely filled with acetone (represented by the squares and triangles), and

CO₂ and acetone confined in the pores of a mesoporous silica aerosol (solid partially filled with acetone) (represented by the diamonds).

In all cases, a linear relationship between the concentration of dissolved CO₂ (on the y-axis) and the pressure at equilibrium (on the x-axis) is observed, suggesting that Henry's law is still true at nanometric scale, but not with the same constant as at macroscopic scale. In such a situation, the solubility can be obtained directly from the slope of the line. The solubilities are expressed in an a dimensional manner, as the percentage relationship between the concentration of CO₂ in the liquid and in the gas.

The solubility of the volumic system, called the reference, is of the order of 700%, which corresponds substantially to the values generally found in the literature.

As can be seen in FIG. 5, the solubility of the CO₂ in the acetone has increased by a factor of 2 (s=1300%) compared with the reference results, when the acetone was confined in the silica aerosol, having average pore sizes of approximately 25 nanometres.

In all the following, oversolubility is defined as the ratio of solubility of the gas in the solvent confined in the mesopores to the solubility of the gas in the same solvent in bulk form, in similar experimental conditions.

The diffusion of the CO₂ in the confined acetone is extremely rapid, (the duration of the experiment is approximately a few seconds) as a result of the large liquid surface area.

The apparent difference between the results observed for the solubility of the CO₂ in the acetone by volume and the acetone completely filling the solid may be due to a lack of stabilization time in this latter case (the duration of each experiment can reach several hours).

Referring once again to FIG. 1, the installation 1 also comprises means 11 of releasing (recovering) the dissolved gas. It might also comprise a monitoring device 12 suitable for real-time checking of the presence or absence of this gas in the output gas flow circulating in the gas-discharge line 4.

The system which has just been described operates as follows.

During a collection phase, the input gas flow, such as combustion gases or fumes are introduced via the gas-feed line 2 into the enclosure 3 containing the soaked solid 7. The gaseous input mixture thus sweeps the soaked solid 7, and the CO₂ is dissolved in the solvent contained in the pores, so that the output gas flow contained in the gas-discharge line 4 essentially contains no CO₂ (less than 1%, preferably less than 0.1% by volume). This output gas flow is for example sent to other processes or released into the atmosphere 13.

In the case of a chemical solvent, such as an amine solvent, due to the fact that the solvent is contained in pores, the solubility process has a rapid kinetic, due to the extended contact surface between the solvent and the gaseous mixture. Further, the confinement of the solvent in nanometric pores severely limits the evaporation of the solvent since, at this scale, the saturation vapour pressure of the solvent is very low.

In the case of a physical solvent, such as acetone, the advantages to be mentioned, compared with the chemical solvent, are for some physical solvents a low cost of the solvent. Further, for physical solvents, the solubility of the carbon in the solvent increases with the partial pressure of carbon dioxide in the enclosure 3.

When the appropriate monitoring device 12 detects too great a quantity of carbon dioxide (i.e. greater than a predetermined threshold depending on the application) in the output gas flow in the discharge line 4, the feed of input gas flow is interrupted via the inlet valve 5, and the carbon dioxide is released (recovered) from the solvent to be sent to later treatments, such as a liquefaction or storage, or others 14.

The carbon dioxide is released or recovered via the release means 11 contained in the enclosure 3. For example, in the case of a physical solvent, the release means 11 could comprise pressure-regulation means adapted to decrease the (partial) pressure of the gas contained in the enclosure 3, corresponding to the dissolved gas so as to release the dissolved gas from the solvent.

In the case of a chemical solvent, the release means 11 can comprise temperature regulation means, in particular heating, suitable for heating the soaked solid 7 in order to release the gas. For CO₂, in comparison with the patent U.S. Pat. No. 6,500,397 cited above, the heating energy to be provided in the present case is substantially less than that provided for in this prior document, due to the smaller volume of solvent to be heated with respect to the volume of dissolved carbon dioxide, due to the phenomenon of supersolubility.

Thus, the method described above is largely reversible. As a result, the steps of gas collection and release can be repeated periodically. Furthermore, as represented in FIG. 5, it can be provided to use several enclosures 3 in parallel (for example two enclosures, as shown, or more), some collecting and others releasing, alternately, so as to be able to treat a permanent stream of input gas flow. Clearly, the latter is always ordered in the direction of the units working in the collection step.

For the manufacture of such an installation, the mesoporous solid is manufactured in a conventional manner, and partly filled with solvent. The γ-alumina and silica are for example produced by sol/gel processes. The filling is partial, as shown in particular in FIG. 2, such that the edges 15 of the pores emerge above the level of the liquid 10 in a majority of the pores of the solid. For example, the ratio of the volume of liquid to the total volume of the solid is of the order of 20% to 99%. A partial filling can for example be obtained by completely filling the solid, then evaporating some of the solvent under primary vacuum, until a desired partial filling is obtained. Gravimetry is used, with knowledge of the density of the solvent and the pore volume of the material, to determine the correct weight of liquid starting from which it can be assured that the liquid is confined in the pores.

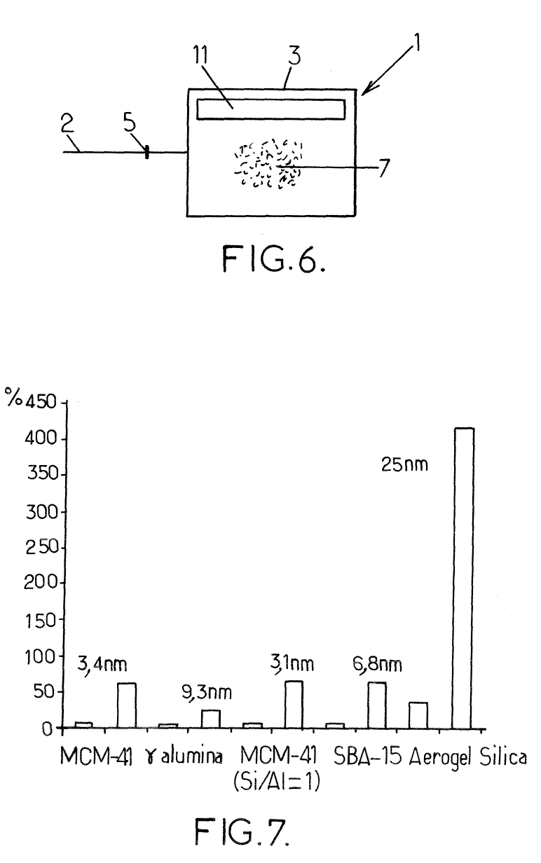

FIG. 6 shows schematically an installation 1 for the stocking (storage) of a gas. This installation comprises a gas-feed line 2 opening into an enclosure 3. An inlet valve 5 make it possible to open or close the gas-feed line 2, as desired.

The gas-feed line 2 carries an input gas flow which in the second embodiment, comprises substantially only one gas to be stored. Since it is not possible to guarantee that a gas will be absolutely 100% pure due to impurities and/or imperfections in the gas manufacturing process, it is meant by “substantially” that the gas is considered sufficiently pure for the target application. For example, the input gas flow comprises substantially pure H₂, i.e. more than 99,99% of the gas or even more than 99,9999% of the gas.

The input gas flow is carried by the gas-feed line 2 into the enclosure 3 where there is located a soaked solid 7 intended for the collection and storing of H₂ from the input gas flow. This soaked solid 7 can for example be in powder or pellet form, in the form of rods, rings or tubes or in any other suitable form. It is constituted by a mesoporous solid 8 containing in its pores 9 a liquid solvent 10 which, in this second embodiment, is a solvent 10 of dihydrogen (FIG. 2).

As a mesoporous solid, the same solids as described above in relation to the first embodiment can be used (see table 1, related description, and FIGS. 3a-3c).

Another solid of interest is aerogel. Aerogel, in particular silica aerogel, is a mesoporous material with pores of a size less than 100 nm, very low density (from 1 mg/cm³ to a few mg/cm³ (for example 10 mg/cm³)) and high rigidity.

Table 1 is reproduced here, with the addition of the characteristics of aerogel.

TABLE 3
Characterization of the texture of the solids
described, based on N₂ adsorption at 77K

| | | | MCM- | Aerogel |
|---|---|---|---|---|
| | γ-alumina | silica | 41 | silica |
| Skeletal density (g cm⁻³) | 3.5 | 2.1 | 2.1 | 0.09 |
| Specific surface area BET | 235 | 309 | 1065 | 407 |
| (m²g⁻¹) | | | | |
| Pore volume (BDB^{(a)}) (cm³ g⁻¹) | 0.62 | 1.12 | 1.09 | 3.383 |
| Average pore size (BJH^{(b)}) (nm) | 10.9 | 13.0 | 3.4 | 23.8 |

^{(a)}Broekhoff-de-Boer;
^{(b)}Barrer-Joyner-Halenda

Unlike other meroporous materials such as MCM, aerogel silica has a very peculiar fractal pore geometry. This provides with the very low density of such materials, which is of interest in applications where total mass of the system is to be minimized.

The ratio of surface area to volume of aerogel silica can be calculated as 407*0.09=37 m²/cm³ of the solid material. The surface area to volume ratio of the other materials is much higher. For example, for MCM-41, it is of about 2240.

As regards the liquid solvent of the H₂, one might, for example, consider n-hexane, ethanol, CHCl₃, CCl₄, water or others.

FIG. 7 represents results of experiments showing, for a plurality of the above-listed solids, the results of solubility of H₂ in n-hexane (left-hand side for each solid) and ethanol (right-hand side for each solid). Further the mean pore size of each solid is indicated. Oversolubility of hydrogen, in both solvents, in solids of pore size less than 10 nm is experimentally noted. These results also show that, for all solids, solubility of H₂ in n-hexane is greater than in ethanol at room temperature.

Unexpected results of very high oversolubility of H₂ were obtained in aerogel silica, of a mean pore size of 25 nanometers, both for n-hexane solvent (solubility of about 400%) and ethanol solvent (solubility of 30%).

Table 4 below shows test results in relation with FIG. 7.

TABLE 4
Quantity of stocked H₂ in n-hexane as a function of confinement solid

| | γ- | MCM- | MCM-41 | SBA | |
|---|---|---|---|---|---|
| Solid | alumina | 41 | (Si/Al = 1) | 15 | Aerogel |
| Mean pore size (nm) | 9.3 | 3.4 | 3.1 | 6.8 | 25 |
| T (K) | 295 | 287 | 298 | 292 | 276 |
| Solubility (kg/m³) | 0.1283 | 0.1796 | 0.0993 | 0.1053 | 0.6821 |
| Quantity of dissolved H₂ at 2 bars | 0.08 | 0.19 | 0.02 | 0.14 | 2.31 |
| (g H₂/kg dry solid) | | | | | |
| Quantity of dissolved H₂ at 2 bars | 0.06 | 0.11 | 0.02 | 0.07 | 0.72 |
| (g H₂/kg soaked solid) | | | | | |

Thus, unexpectedly, an oversolubility of 40 is detected for H₂ in n-hexane confined in aerogel.

This result shows that 0.72 g H₂ can be stored per kilo of soaked solid (2.31 g H₂ per kilo of dry solid) at 2 bars, at 276K.

Depending of the kind of aerogel used, storing of at least 0.5 g H₂/kg of soaked solid, or 2 g H₂/kg of dry solid can be expected at 2 bars, and at ambient temperature (about 276K).

This result is expected to be verified, not only for the present embodiment, but, varying the kind of mesoporic used, for mesoporic solids having a low ratio of surface area to volume, for example of less than 100 m²/cm³, or at least less than 50 m²/cm³.

The particular structure of aerogel leads to particular phase transitions, which are not witnessed in bulk liquids and in liquids confined in the other mesoporous materials listed above.

As shown all along this specification, liquids confined in mesoporous volumes tend to have different properties than bulk liquids. This is verified when the property in question is solubility of a certain gas. Without wishing to be bound by theory, the inventors contemplate the fact that, for such solids as silica aerogel, these properties also include density (and/or viscosity) of the liquid. This would mean that the liquid is re-ordered when confined in pores of such a material, this re-ordering causing this change in viscosity and/or density. It is believed that this re-organization of the n-hexane molecules in the pores of the aerogel would allow for even more interaction of the n-hexane and the molecules of dihydrogen, and hence increased oversolubility.

Whereas, for the others above-listed mesoporous materials, the interaction of the confined liquid with the solid surface is merely physical (capillary condensation, equation of Laplace), in the case of aerogel, there is another stronger chemical interaction between the solid surface and the confined liquid, which leads to such re-organization.

Thus, during the manufacture of the gas handling installation according to this embodiment, when the solid is soaked with the liquid, the liquid will be re-ordered according to the above-described phenomenon.

Thus, it is expected that other materials than aerogel, but offering the same kind of interaction with the liquid, would provide similarly interesting results, which materials are to be encompassed in the scope of the disclosure.

Referring once again to FIG. 1, the installation 1 also comprises means 11 of releasing the dissolved H₂.

The system which has just been described operates as follows.

During a stocking phase, the gaseous input flux is introduced under pressure via the gas-feed line 2 into the enclosure 3 containing the soaked solid 7. The gaseous input mixture thus sweeps the soaked solid 7, and H₂ is dissolved in the solvent contained in the pores. The concentration of dissolved H₂ was experimentally shown to be linearly related to the pressure in the tank.

When the stocking threshold is reached, the enclosure 3 can be disconnected from the input line. The enclosure 3 thus forms a tank or container of H₂. The container encloses a gaseous phase and a meso-confined liquid phase in which H₂ is dissolved. The tank is made resistant to pressures between 1 and 60 bars, or for example to pressure less than 30 bars, depending on the required application.

The enclosure 3 can thus be displaced to a place where H₂ is to be released. In that place, it can be connected to an output line, to provide H₂ to a device using it.

For example, H₂ is used in a fuel cell, as a source of electrical power, or as a source of mechanical power in an engine or thermal turbine.

The output line comprises a gas discharge line 4 and an outlet valve 6 such as shown on FIG. 1.

The hydrogen is released or recovered via release means, such as by opening in a controlled manner the outlet valve. Release means 11 can be contained in the enclosure and can comprise temperature regulation means, in particular heating, suitable for heating the previously frozen soaked solid 7 in order to release the hydrogen.

As an alternative, the temperature regulation means could be provided in a delivery station outside the enclosure. In any case, the storing/releasing process is highly reversible.

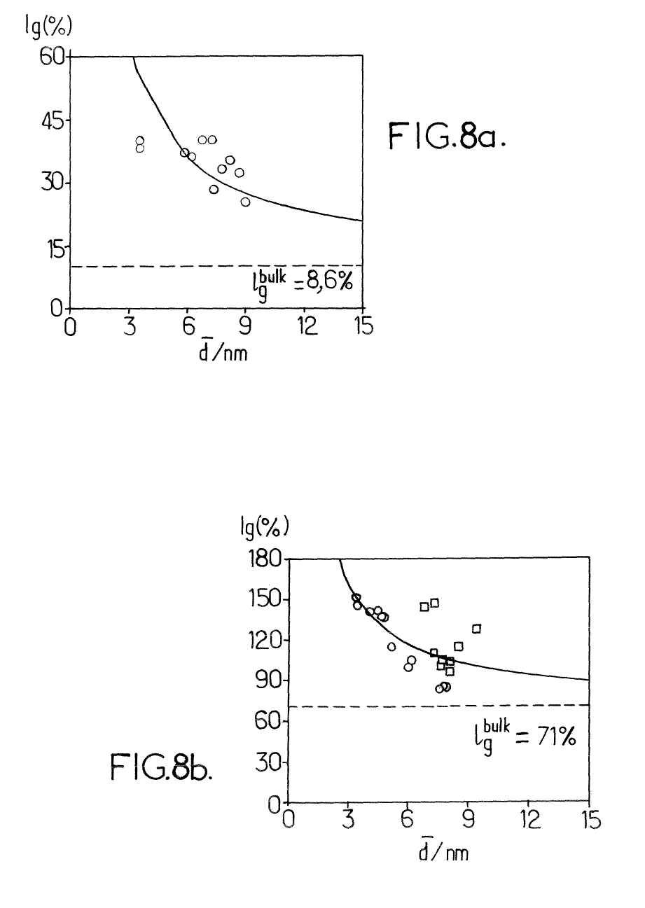

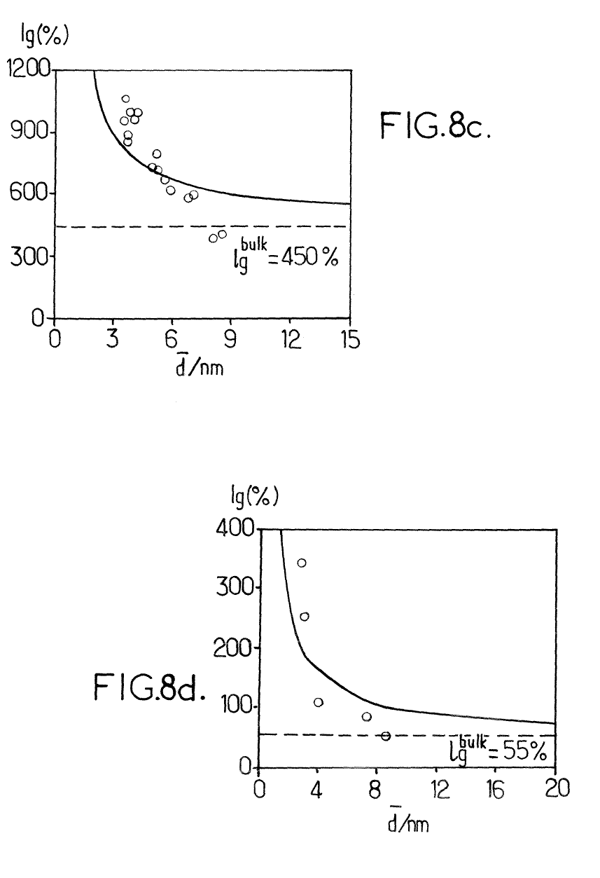

Many other applications are possible, for example FIG. 8a to 8d illustrate results of solubility experiments of a gas in a solvent confined in pores of a mesoporic solid as a function of the mean pore diameter, as well as, in dotted lines, the bulk solubility (solubility of the gas in the solvent in bulkform). FIG. 8a provides results of H₂ dissolved in CCl₄ confined in γ-alumina. On FIG. 8b, circles show the solubility of CH₄ in the same solvent and solid. Squares show the solubility of CH₄ in CCl₄ confined in pores of silica.

On FIG. 8c, solubility of C₂H₆ in CCl₄ confined in γ-alumina is shown. In FIG. 8d, solubility of CH₄ in the CS₂ confined in γ-alumina is shown. The solid lines refer to the mathematically predicted trend for solubility for these experiments.

These results show that, for a given gas, for a given solvent, for a given solid material, solubility tends to increase when the mean pore diameter decreases. This was also verified experimentally for H₂ in ethanol and n-hexane.

1. A method for dissolving a gas, in which a soaked solid comprising a porous substrate comprising a plurality of pores each having a size less than 100 nanometres and each partially filled by a solvent of said gas, is swept with an input gas flow comprising at least said gas.

2. The method of claim 1, in which the solvent is a physical solvent.

3. The method of claim 1, in which the solvent is a chemical solvent.

4. The method of claim 1, in which the input gas flow is placed in contact with the solvent contained in the pores.

5. The method of claim 1, in which a concentration of said gas in an output gas flow from the soaked solid is monitored.

6. The method of claim 1, wherein said gas is carbon dioxide, to be collected from an input gas flow resulting from a combustion and further comprising at least dinitrogen [N₂].

7. The method of claim 1, wherein said gas is dihydrogen (H₂) and wherein said input gas flow comprises substantially only said gas.

8. The method of claim 7, comprising using a liquid previously re-ordered in the pores.

9. The method of claim 7, wherein there is a chemical re-ordering interaction between the solid and the liquid.

10. The method of claim 7, wherein the pores have a fractal geometry.

11. The method of claim 7, comprising sweeping a porous substrate having a ratio of surface area to volume of less than 100 m²/cm³, preferably of less than 50 m²/cm³.

12. The method of claim 1, in which the input gas flow comprises water vapour.

13. A method of treatment of a gas comprising a method for dissolving a gas according to claim 1, and further comprising a recovery step of the gas dissolved in the pores.

14. The method of claim 13, in which the soaked solid is kept in a gaseous environment, and in which the recovery step comprises a pressure variation of the gaseous environment.

15. The method of claim 13, in which the recovery step comprises a temperature variation of the soaked solid.

16. The method of claim 13, in which the sweeping and recovery are carried out alternately and repeatedly.

17. The method of claim 16, in which the input gas flow is sent alternately to a first and a second soaked solid, one of the soaked solids being submitted to a recovery step when the other is swept by the input gas flow.

18. A method for generating an output gas flow, wherein a gas is recovered from a soaked solid comprising a porous substrate comprising a plurality of pores each having a size less than 100 nanometers and each partially filled by a solvent of said gas.

19. An installation for stocking a gas comprising a soaked solid comprising a porous substrate comprising a plurality of pores each having a size less than 100 nanometres and each partially filled with a solvent of the said gas.

20. An installation for collecting a gas comprising the installation of claim 19, and further comprising an input device adapted to introduce an input gas flow comprising at least said gas, suitable for sweeping the soaked solid with the input gas flow.

21. The installation of claim 19, further comprising an output device adapted to release an output gas flow comprising at least said gas.

22. The installation of claim 21, also comprising at least one and preferably all of the following characteristics:
a temperature regulation device adapted to regulate the temperature of the soaked solid,
a pressure regulation device adapted to regulate the pressure of an atmosphere in which the soaked solid is contained, and
a monitoring device adapted to monitor the content of said gas in an output gas flow.

23. The installation of claim 19, wherein the input device is adapted to introduce a gaseous input mixture resulting from a combustion, and comprising at least carbon dioxide as said gas, and nitrogen [N₂].

24. The installation of claim 19, wherein said gas is dihydrogen (H2), and wherein said input gas flow comprises substantially only said gas.

25. The installation of claim 24, wherein the liquid is re-ordered in the pores.

26. The installation of claim 24, wherein there is a chemical re-ordering interaction between the solid and the liquid.

27. The installation of claim 24, wherein the pores have a fractal geometry.

28. The installation of claim 24, wherein over 2g of H₂ are dissolved per kilo of dry solid at 2 bars and 276K.

29. The installation of claim 24 wherein said solid has a ratio of surface area to volume of less than 100 m²/cm³, preferably of less than 50 m²/cm³.

30. The installation of claim 19, wherein the mean pore size is less than 20 nm, preferably less than 15 nm.

31. A method for the manufacture of an installation for the stocking of a gas comprising:
manufacturing a porous substrate comprising a plurality of pores each having a size less than 100 nanometres,
partially filling the pores with a solvent of said gas, and
supplying an input device adapted to introduce an input gas flow comprising at least said gas, suitable for sweeping the solvent with the input gas flow.

32. The method of claim 31, wherein said gas is CO₂, wherein the input gas flow is a gaseous input mixture resulting from a combustion and further comprising at least nitrogen.

33. The method of claim 31, wherein said gas is H₂, wherein the input gas flow substantially comprises only said gas.

34. A method for collecting carbon dioxide [CO₂] in a gaseous mixture resulting from a combustion, in which a soaked solid comprising a porous substrate comprising a plurality of pores each having a size less than 100 nanometers and each partially filled by a solvent of CO₂, is swept with a gaseous input mixture comprising at least CO₂ and nitrogen [N₂].

35. An installation for stocking a gas comprising an enclosure adapted to stand internal pressures of up to 30 bars, preferably of up to 60 bars, and containing an aerogel having pores each partially filled with n-hexane.
